(19) United States
(12) Patent Application Publication
(10) Pub. No.: US 2026/0146871 A1
(43) Pub. Date: May 28, 2026

(54) POSITION MEASURING DEVICE

(71) Applicant: DR. JOHANNES HEIDENHAIN GmbH, Traunreut (DE)

(72) Inventors: Bernhard Musch, St. Georgen (DE); Johann Gressitzek, Burgkirchen (DE)

(21) Appl. No.: 19/393,613

(22) Filed: Nov. 19, 2025

(30) Foreign Application Priority Data
Nov. 27, 2024 (DE) 10 2024 003 934.1

(51) Int. Cl. G01D 5/347

(52) U.S. Cl. CPC G01D 5/34715

(57) ABSTRACT

A position measuring device for detecting a relative position of two objects movable relative to one another in a main movement direction and further degrees of freedom, the measuring device including a scale carrier and a scanning assembly. The scale carrier has a first, second, and third surface, each defining a plane, at least one measurement graduation being arranged on each surface. The scanning assembly is configured to move relative to the scale carrier and includes a plurality of scanning units configured to generate displacement-dependent position signals from scanning of the measurement graduations, each of the first, second, and third surfaces being assigned at least one scanning unit. The plane defined by the second surface divides a surrounding space into two half-spaces. The first surface is arranged in a first of the two half-spaces. The third surface is arranged in a second of the two half-spaces.

### CROSS REFERENCE TO RELATED APPLICATIONS

This application claims benefit to German Patent Application No. DE 10 2024 003 934.1, filed on Nov. 27, 2024, which is hereby incorporated by reference herein.

### FIELD

The present invention relates to a position measuring device.

### BACKGROUND

WO 2017/080612 A1 discloses a position measuring device for measuring the relative position of two objects that are movable relative to one another in an advancing direction and in further degrees of freedom. This position measuring device comprises a prismatic carrier body, which is elongate in the advancing direction, having a plurality of surfaces which each carry a measurement graduation, and having a scanning assembly, which is movable relative thereto and has a plurality of scanning units for scanning the measurement graduations. Position measuring devices of this kind are used, for example, to measure errors in coordinate measuring machines. The measured values detected thereby can be used to correct errors in the coordinate measuring machine and to calibrate the coordinate measuring machine.

In the position measuring device known from WO 2017/080612 A1, a mechanical holder that wraps around the carrier body is required on the scanning side for the plurality of scanning units. This kind of wraparound tends to require a certain amount of installation space, which is not available in some cases.

### SUMMARY

In an embodiment, the present disclosure provides a position measuring device for detecting a relative position of two objects, the objects being movable relative to one another in a translatory main movement direction and in further degrees of freedom, the measuring device comprising a scale carrier and a scanning assembly. The scale carrier is elongate in the main movement direction and has a first, a second, and a third surface, which each define a plane, at least one measurement graduation being arranged on each of the first, second, and third surfaces. The scanning assembly is configured to move relative to the scale carrier and comprises a plurality of scanning units configured to generate displacement-dependent position signals from scanning of the measurement graduations, each of the first, second, and third surfaces being assigned at least one of the plurality of scanning units. The plane defined by the second surface divides a surrounding space into two half-spaces. The first surface is arranged in a first half-space of the two half-spaces. The third surface is arranged in a second half-space of the two half-spaces.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a illustrates a sectional view of a first embodiment example of the position measuring device according to the present disclosure comprising a carrier body and a scanning assembly;

FIG. 1b illustrates a plan view of the position measuring device according to FIG. 1a;

FIG. 2 illustrates a plan view of a second embodiment example of the position measuring device according to the present disclosure;

FIG. 3 illustrates a plan view of a third embodiment example of the position measuring device according to the present disclosure; and

FIG. 4 illustrates a plan view of a fourth embodiment example of the position measuring device according to the present disclosure.

### DETAILED DESCRIPTION

In an embodiment, the present disclosure provides a compact position measuring device that allows the relative position of two objects that are movable relative to one another to be precisely measured in a plurality of degrees of movement.

The position measuring device according to the present disclosure is configured to detect the relative position of two objects, the objects being movable relative to one another in a translatory main movement direction and in further degrees of freedom. The apparatus comprises a scale carrier, which is elongate in the main movement direction and has a first, a second, and a third surface, which each define a plane, at least one measurement graduation being arranged on each surface. Also provided is a scanning assembly that is movable relative to the scale carrier and comprises a plurality of scanning units configured to generate displacement-dependent position signals from the scanning of the measurement graduations, each surface being assigned at least one scanning unit. The plane defined by the second surface divides the surrounding space into two half-spaces, the first surface, which has at least one measurement graduation, being arranged in a first half-space, and the third surface, which has at least one measurement graduation, being arranged in the second half-space.

Preferably, the angle of intersection between the first and the second plane, and the angle of intersection between the second and the third plane, are each selected in the range between 60° and 179°, the angle of intersection between the first and the second plane being drawn in the first half-space, and the angle of intersection between the second and the third plane being drawn in the second half-space.

Advantageously, the two angles of intersection are selected such that the first plane and the third plane are oriented in parallel with one another.

Furthermore, it can be provided that the line of intersection between the first and the second plane, and the line of intersection between the second and the third plane, are each oriented in parallel with the main movement direction, and the second surface is located between said two lines of intersection.

Preferably, the three surfaces of the scale carrier, the measurement graduations, and the scanning units are arranged and configured such that the position of the scanning assembly relative to the scale carrier can be determined in six degrees of movement.

In an advantageous embodiment, at least two surfaces are assigned at least two scanning units.

Furthermore, at least one surface can be assigned two scanning units having different measurement directions, the measurement direction of one scanning unit indicating the translatory displacement direction in which the displacement-dependent position signals can be generated.

In this case, it can be provided that, on the surface assigned to the scanning units having different measurement directions, the scale carrier has two differently oriented measurement graduations, the graduation marks of which are not arranged in parallel with one another.

Preferably, the measurement graduations are formed as incremental graduations that can be optically scanned.

In an embodiment, it is provided that:
each surface is assigned at least one scanning unit of which the measurement direction is oriented perpendicularly to the main movement direction, and
a second surface and a further surface are each assigned at least two scanning units of which the measurement directions are oriented perpendicularly to the main movement direction, and
at least one surface is assigned at least one scanning unit of which the measurement direction is oriented in parallel with the main movement direction.

Furthermore, it can be provided that:
two adjacent surfaces are assigned four scanning units arranged in the main movement direction and having a measurement direction perpendicular to the main movement direction, and adjacent scanning units are each assigned to different surfaces, and
two further scanning units, at least one of which is assigned to the further surface, are arranged in gaps between the four other scanning units in the main movement direction.

In addition, it can be provided for the graduation marks of the measurement graduations and the measurement directions of the scanning units to be arranged at an angle to either the main movement direction or a perpendicular to the main movement direction.

In a further embodiment, it can be provided that:
each surface is assigned two measurement graduations of which the graduation marks are arranged in mirror symmetry with one another in relation to a central axis of symmetry and at an angle to the main movement direction, and
the two measurement graduations on each surface are each assigned one scanning unit, and the two scanning units of one surface have measurement directions that are orthogonal to one another.

The position measuring device according to the present disclosure allows the required scanning units to be arranged compactly on one side of the scale carrier, thus avoiding any wrapping-around thereof. The scanning units can thus be mechanically retained in the scanning assembly with less mass and with greater rigidity than in a measurement arrangement having a wraparound. Furthermore, it is guaranteed that the degrees of movement are detected highly sensitively. Depending on the measurement task, the position measuring device according to the present disclosure can be designed flexibly in relation to certain requirements, for example for applications that require a compact overall arrangement or applications that require a larger range of motion in a particular movement direction.

Further details and advantages of the present disclosure will be explained on the basis of the following description of possible embodiments of the present disclosure in conjunction with the drawings.

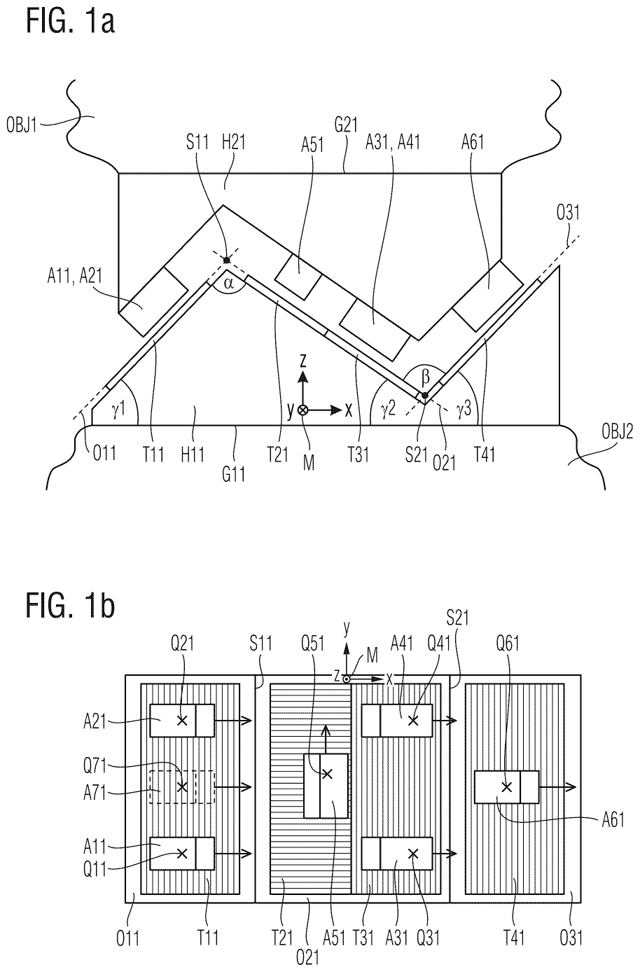

A first embodiment example of the position measuring device according to the present disclosure will be explained below on the basis of the schematic views in FIGS. 1a and 1b. In this regard, FIG. 1a is a sectional view of the position measuring device in the x-z plane, and FIG. 1b is a plan view of the position measuring device from the z direction.

The position measuring device shown is used for detecting the relative position of two objects OBJ1, OBJ2 (only indicated schematically in FIG. 1a) in all six rigid-body degrees of movement; hereinafter, these will be referred to simply as degrees of movement. The objects OBJ1, OBJ2 can, for example, be machine components that are moved relative to one another in a defined manner in the application and whose relative positions have to be detected. In the example shown, the main movement direction of the object OBJ1 relative to the object OBJ2 runs along the y axis of the coordinate system M indicated. In FIG. 1a, the main movement direction is accordingly oriented perpendicularly to the plane of the drawing. The main movement direction is distinguished in that it is in this direction that the position measuring device according to the present disclosure should enable the largest possible range of motion. In the remaining five degrees of movement, the movements are substantially smaller. On the basis of the coordinate system M in FIG. 1a, the five other degrees of movement can be indicated as follows:
Translation of the object OBJ1 in the x direction of the coordinate system M
Translation of the object OBJ1 in the z direction of the coordinate system M
Rotation of the object OBJ1 about the x axis of the coordinate system M
Rotation of the object OBJ1 about the y axis of the coordinate system M
Rotation of the object OBJ1 about the z axis of the coordinate system M

In the position measuring device according to the present disclosure, the object OBJ2 is connected to a scale carrier H11. The scale carrier H11 has at least three surfaces which each define a plane O11, O21, O31, at least one measurement graduation T11, T21, T31, T41 being arranged on each surface. The measurement graduations T11, T21, T31, T41 can be formed, for example, as incremental graduations that each consist of a periodic arrangement of graduation regions.

As an alternative to the example shown, the object and the scale carrier can be formed as a single component. Furthermore, it can be provided for the measurement graduations not to be arranged as separate components on the scale carrier, but to be formed as integral component parts of the scale carrier.

A scanning assembly H21 of the position measuring device is connected to the other object OBJ1 and comprises a plurality of scanning units A11, A21, A31, A41, A51, A61 that are rigidly coupled together and each configured to generate displacement-dependent position signals from the scanning of the measurement graduations T11, T21, T31, T41 on the scale carrier H11. As an alternative to the example shown, the object and the scanning assembly can be formed as a single component. To detect the six degrees of movement, the scanning assembly H21 has at least six scanning units A11, A21, A31, A41, A51, A61.

The individual scanning units A11-A61 are each configured to detect, by scanning the associated measurement graduation T11-T41, the displacement of each scanning unit A11-A61 relative to the measurement graduation T11-T41. Within the context of the present disclosure, the scanning units A11-A61 can make use of optical, magnetic, inductive, or capacitive measurement principles in this case. For high-resolution measurement, an optical scanning principle, for instance, can be used, as known, for example, from EP 0 163 362 A1 belonging to the applicant. The associated measurement graduation can then be formed depending on the scanning principle used. For instance, in the case of optical scanning, an incremental measurement graduation consists of a periodic arrangement of graduation regions or graduation marks having different optical properties, e.g., graduation regions having high and low reflectivity.

Hereinafter, the translatory displacement direction in which each displacement-dependent position signal can be generated by means of the scanning units, or in which the position signals change to the greatest extent during displacement over a fixed path, will also be referred to as the measurement direction; in this case, the measurement direction can be depicted by a three-dimensional vector. The drawings illustrate the measurement directions assigned to each scanning unit A11-A61 by means of arrows on the scanning units A11-A61. It should be noted that the measurement direction vectors are generally not flat within the plane of the drawing since the measurement graduations T11-T41 are arranged at an angle to the plane of the drawing, as can be seen from the view in FIG. 1a, for example. Usually, the measurement direction of each scanning unit A11-A61 results from the orientation of the associated measurement graduation T11-T41, the orientation of the scanning unit A11-A61, and the specific construction of the scanning unit A11-A61. In the present disclosure, use is made only of scanning units A11-A61 having measurement directions designed to be within the plane of the measurement graduation T11-T41.

It is also pointed out that in the drawings the scanning units A11-A61 used are shown as separate objects for clarity reasons. In practice, however, a plurality of scanning units can be integrated in a joint housing in order thus for a plurality of scanning units to use optical and/or electronic components jointly, for example when an optical scanning principle is used.

Hereinafter, different design rules and considerations are set out regarding the geometric configuration of the scale carrier H11, the arrangement of the surfaces having the measurement graduations T11, T21, T31, T41, and the configuration of the scanning assembly H21 in the position measuring device according to the present disclosure.

In this regard, the scale carrier H11 is configured such that the planes O11, O21, O31 of the three surfaces intersect in at least two lines of intersection S11, S21 that run in the y direction and thus in parallel with the main movement direction.

The measurement graduations T21, T31 assigned to the second plane O21 or second surface are located between the two lines of intersection S11, S21 of the second plane O21 with the first plane O11 and the third plane O31, respectively.

The second plane O21 divides the space that surrounds it into two half-spaces. The first surface O11, which has at least one measurement graduation T11, is arranged in one of the half-spaces (hereinafter also referred to as the first half-space; bottom left in FIG. 1a); the third surface O31, which likewise has at least one measurement graduation T41, is arranged in the other half-space (hereinafter also referred to as the second half-space; top right in FIG. 1a).

The angle of intersection between the first plane O11 and the second plane O21 is denoted by a in FIG. 1a, this angle of intersection being drawn in the first half-space (bottom left), in which the measurement graduation T11 of the first plane O11 is located. In FIG. 1a, β denotes the angle of intersection between the second plane O21 and the third plane O31, the angle of intersection β being drawn in the other, second half-space (top right), in which the measurement graduation T41 of the third plane O31 is located. Preferably, the angles of intersection α, β are each selected in the range between 60° and 179°. For practical reasons, the selection α=β can also be advantageous here. In this case, the two planes O11 and O31 are oriented in parallel with one another. Furthermore, the case of α≈90° and β≈90° can be advantageous in order to establish the six degrees of movement from the displacement-dependent position signals.

As can be seen from FIGS. 1a and 1b, at least two of the three planes O11, O21, O31 are each assigned more than one scanning unit A11-A61. In the specific example, the two scanning units A11, A21 are assigned to the first plane O11, and the three scanning units A31, A41, A51 are assigned to the second plane O21.

It is also provided that at least two scanning units A11-A61 having different measurement directions are assigned to at least one of the surfaces or planes O11-O31. In the example of FIGS. 1a and 1b, this is the second surface or second plane O21, to which the scanning unit A51, the measurement direction of which is oriented in the y direction, is assigned; the two scanning units A31, A41, the measurement direction of each of which is oriented perpendicularly to the y direction, are also assigned to this plane O21. As can be seen from FIG. 1b, for this purpose two measurement graduations T21, T31, the graduation marks of which are oriented not in parallel with one another but orthogonally to one another, are arranged on the second surface in separate tracks. The measurement graduation T21 consists of a periodic arrangement of graduation marks in the y direction, i.e., the measurement direction of the associated scanning unit A51; the longitudinal direction of the graduation marks extends in the indicated x direction, i.e., perpendicularly to the y direction. The measurement graduation T31 consists of a periodic arrangement of graduation marks perpendicular to the y direction, i.e., the measurement direction of the two associated scanning units A31, A41. As an alternative to separate tracks, a measurement graduation that allows scanning units having different measurement directions to be operated on a single track could also be provided. Specifically, in the present embodiment example a so-called grid encoder measurement graduation can be used, which is scanned by scanning units having measurement directions that are orthogonal to one another.

In the specific embodiment example of FIGS. 1a and 1b, it is also provided that each of the three planes O11, O21, O31 is assigned at least one scanning unit having a measurement direction perpendicular to the main movement direction. According to FIG. 1b, these are the scanning units A11, A21, A31, A41, A61. Furthermore, the middle plane O2 and at least one further plane O1 or O2 are assigned at least two scanning units having measurement directions oriented perpendicularly to the main movement direction. Lastly, at least one of the three planes O1, O2, O3 is assigned a scanning unit of which the measurement direction is oriented in parallel with the main movement direction, i.e., the y direction; in the present case, this would be the scanning unit A51.

In the example shown in FIGS. 1a and 1b, the scanning assembly H21 has a planar base G21, and the scale carrier H11 has a planar base G11.

These two bases G21, G11 are oriented in parallel with the main movement direction, i.e., the y direction. Furthermore, the two bases G11, G21 are oriented approximately in parallel with one another within operating tolerances. In this case, slope angles γ₁, γ₂, γ₃ between the surfaces O11, O21, O31 and the base G11 of the scale carrier H11 can be defined, as shown in FIG. 1a. The above-mentioned angles of intersection α and β, which characterize the tilts of the different surfaces O11, O21, O32 relative to one another, can then be established by means of the slope angles γ₁, γ₂, γ₃ as follows:

$$α = 180 ° - {γ}_{1} - {γ}_{2} , β = 180 ° - {γ}_{2} - {γ}_{3} .$$

Depending on requirements and the constraints in the measurement application, it can be necessary to form the position measuring device according to the present disclosure such that it fits between the two bases G11, G21 and manages with the smallest possible space between the two bases G11, G21. In this case, it can be advantageous to ensure that one of the two lines of intersection S11, S21 is as close as possible to the base G11; in the example shown in FIG. 1a, this would be the line of intersection S21. As a result, the scanning units A11-A61 move closer to the scale carrier H11. To achieve this, the widths of the measurement graduations T11-T41, the scale widths, and the slope angles γ₁, γ₂, γ₃ have to be selected accordingly. In this regard, relatively small slope angles γ₁, γ₂, γ₃ should preferably be selected; overall, this leads to a flatter and thus more compact construction of the position measuring device.

If space is needed for each separate graduation track for different measurement directions in one plane, scanning units having different measurement directions can preferably be provided solely in one plane O21. In this case, to minimize the installation space it can also be provided to select the slope angle γ₂ of the associated plane O21 to be slightly smaller than the two other slope angles γ₁, γ₃. In this way, there is a larger width available for the surface assigned to that plane O21, without the overall height of the arrangement above the base G11 increasing. This makes it simpler to arrange two measurement graduation tracks on this surface. Only scanning units A11, A21, A61 having the same measurement direction are assigned to the other two surfaces or planes O11, O31 in each case. Accordingly, they only need space for one measurement graduation track.

Furthermore, it can be that a particular measurement task requires the position measuring device according to the present disclosure to allow for a larger range of motion in relation to displacement of the scanning assembly H21 in a direction that lies within the base G11 and is oriented perpendicularly to the main movement direction; in the example of FIGS. 1a and 1b, this would thus be a larger range of motion in the x direction. In this case, it has proven advantageous to select the slope angles γ₁, γ₂, γ₃ to be relatively small. That is because if the scanning assembly H21 moves along a path x in said x direction, the distance between the scanning units A11-A61 and their assigned measurement graduations T11-T41 changes by the quantities x sin γ₁, x sin γ₂, and x sin γ₃, respectively. For instance, in the case of the selection γ₁=γ2=γ₃=45°, a corresponding displacement by x results in the distance between the scanning units A11-A61 and their measurement graduations T11-T41 only changing by the absolute value x sin (45°)=x/\sqrt{2}. Given that the scanning unit drops out if the absolute value of the distance from the measurement graduation deviates by more than h from the nominal distance, the described arrangement thus enables movements in the x direction in the range of −h\sqrt{2}<x<h\sqrt{2} without this leading to the scanning unit dropping out. A factor of \sqrt{2} is thus gained by comparison with an arrangement in which measurement graduations are arranged perpendicularly to the base G11.

On the other hand, it can also be that a particular measurement task requires the position measuring device according to the present disclosure to allow for a larger range of motion in relation to displacement of the scanning assembly H21 in a direction that is perpendicular to the base G11 and oriented perpendicularly to the main movement direction; in the example of FIGS. 1a and 1b, this would thus be a larger range of motion in the z direction. In this case, it has proven advantageous to select the slope angles γ₁, γ₂, γ₃ to be relatively large. That is because if the scanning assembly H21 moves along a path z in said z direction, the distance between the scanning units A11-A61 and their assigned measurement graduations T11-T41 changes by the quantities x cos γ₁, x COS γ₂, and x cos γ₃, respectively. For instance, in the case of the selection γ₁=γ₂=γ₃₌₄₅°, a factor of \sqrt{2} is gained by comparison with an arrangement in which measurement graduations are arranged in parallel with the base G11.

For the first embodiment example of the position measuring device according to the present disclosure as described on the basis of FIGS. 1a and 1b, it is briefly outlined below how to thus establish all six degrees of movement or rigid-body degrees of freedom of the scanning assembly H21 relative to the scale carrier H11.

For simplicity, it is assumed that all the scanning units A11-A61 have the same sensitivity to translation in their measurement direction, i.e., that all the scanning units A11-A61 exhibit the same measured-value change when they are each displaced by the same length in their particular measurement direction.

The measurement directions of the scanning units A11 and A21 are identical. Therefore, the difference between the measured values of these two scanning units A11, A21 is not sensitive to any translation (or displacement) of the scanning assembly H21 but only to a rotational degree of freedom. The greatest sensitivity of said measured-value difference is to rotation of the scanning assembly H21 about a first axis of rotation perpendicular to the plane O11. This first axis of rotation is oriented perpendicularly to the main movement direction, which runs in or in parallel with the indicated y direction.

Furthermore, the measurement directions of the scanning units A31 and A41 are identical. Therefore, the difference between the measured values of these two scanning units A31, A41 is not sensitive to any translation (or displacement) of the scanning assembly H21 but only to a rotational degree of freedom. The greatest sensitivity of said measured-value difference is to rotation of the scanning assembly H21 about a second axis of rotation perpendicular to the plane O21. This second axis of rotation is oriented perpendicularly to the main movement direction. Moreover, the second axis of rotation is not oriented in parallel with the first axis of rotation because the angle-of-intersection selection α=0 or α=180° is ruled out, as indicated above.

To simplify the description, it is still assumed hereinafter that α=β, i.e., that the planes O11 and O31 are parallel. Moreover, it is assumed that the midpoint between the scanning sites Q11 and Q21 of the scanning units A11 and A21 in the coordinate system M has the same y coordinate as the scanning site Q61 of the scanning unit A61.

With respect to its sensitivity to the six degrees of movement, the average of the measured values of the scanning units A11 and A21 acts like the measured value of an imaginary scanning unit A71 having the same measurement direction and having the scanning site Q71 at the midpoint between the scanning sites Q11 and Q21 of the scanning units A11 and A21.

The measurement directions of said imaginary scanning unit A71 and the scanning unit A61 are identical. Therefore, the difference in the measured values of these two scanning units A71, A61 is not sensitive to any translation (or displacement) of the scanning assembly H21 but only to a rotational degree of freedom. The greatest sensitivity is to rotation of the scanning assembly H21 about a third axis of rotation, namely the y axis, because this axis is perpendicular to the shared measurement direction and perpendicular to the distance vector between the scanning sites.

Vectorially, the first, second, and third axes of rotation are linearly independent of one another. Thus, all three rotational degrees of movement can be determined independently of one another by the position measuring device according to the present disclosure.

The measurement directions of the scanning units A11 and A31 are perpendicular to the main movement direction and are linearly independent of one another because the angle-of-intersection selection α=0 or α=180° is ruled out. The measurement direction of the scanning unit A51 is parallel to the main movement direction. Thus, the measurement directions of the scanning units A11, A31, A51 are likewise linearly independent of one another. Thus, by using the measured values of the scanning units A11, A31, A51, all three translatory degrees of freedom of the scanning assembly H21 can be determined independently of one another.

The above explanation is intended solely to roughly illustrate how all six degrees of movement can be determined using the position measuring device according to the present disclosure. In practice, the degrees of movement are generally established by solving a system of equations. For each scanning unit, an equation can be produced by equating the generated measured value with a predicted measured value that can be depicted as a function of the six degrees of movement in consideration of the scanning site and the measurement direction. If more than six scanning units are used, a suitable method can be used to advantageously solve the resulting overdetermined system of equations in consideration of measurement deviations, for example the least squares method.

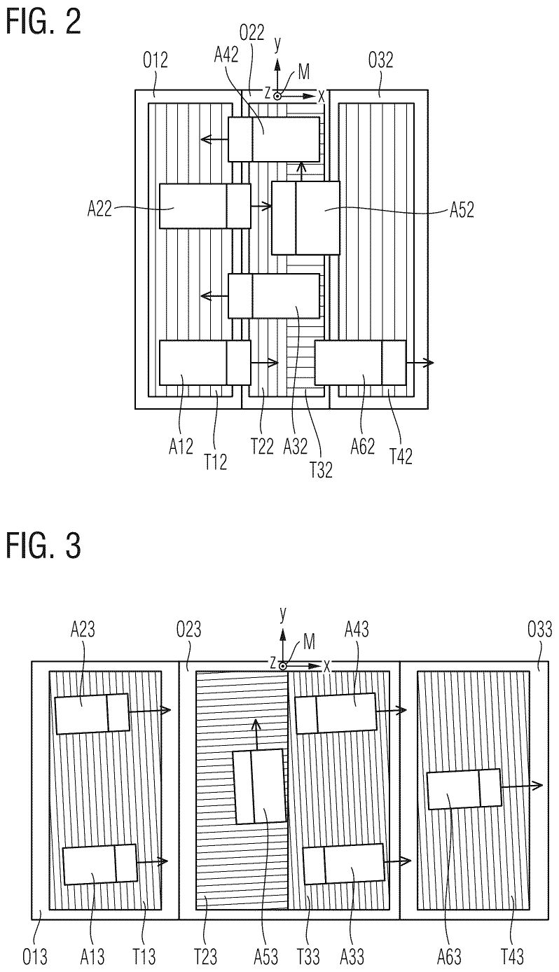

FIG. 2 is a plan view of a second embodiment example of the position measuring device according to the present disclosure. Only the significant differences from the first embodiment example will be explained below.

Thus, this embodiment example is distinguished on account of a particularly compact arrangement of the scanning units A12-A62, of which six are again provided. For this purpose, the scanning units having the same measurement direction are arranged in a manner interlinked at adjoining measurement graduations. Four scanning units A12, A32, A22, A42 having the same measurement direction are distributed in the scanning assembly over two adjacent surfaces O1, O2, specifically in order according to their position in the main movement direction and in an alternating manner in terms of their assignment to one surface O1, O2, or associated measurement graduations T12, T22, and the other. As can be seen from FIG. 2, the measurement direction of each of these four scanning units A12, A32, A22, A42 is oriented perpendicularly to the main movement direction, i.e., the y direction. As can be seen, with respect to their position in the main movement direction, the two other scanning units A52, A62 are advantageously arranged in the scanning assembly in the gaps between the four scanning units A12, A32, A22, A42 already positioned.

The particular advantage of this arrangement is its compact design. Owing to the interlinked arrangement, the measurement graduations T12-T42 can be formed to be particularly narrow, even if the overall size of the scanning units A12-A62 then potentially protrudes into the region of another surface. It has also proven advantageous if the distance between scanning units having the same measurement direction on the same surface, e.g., the distance between the scanning units A12 and A22 and the distance between the scanning units A32 and A42, respectively, is considerably greater than the width of a single scanning unit despite the compact arrangement. This results in the degrees of movement being determined in a numerically well-conditioned manner. That is because the angle of rotation about an axis perpendicular to the measurement graduation plane has to be obtained from the measured-value difference between two such scanning units. If the distance between the scanning units is large enough, then the measured-value difference brought about by the angle of rotation is also large enough and can also be reliably detected despite any interference effects, for example noise.

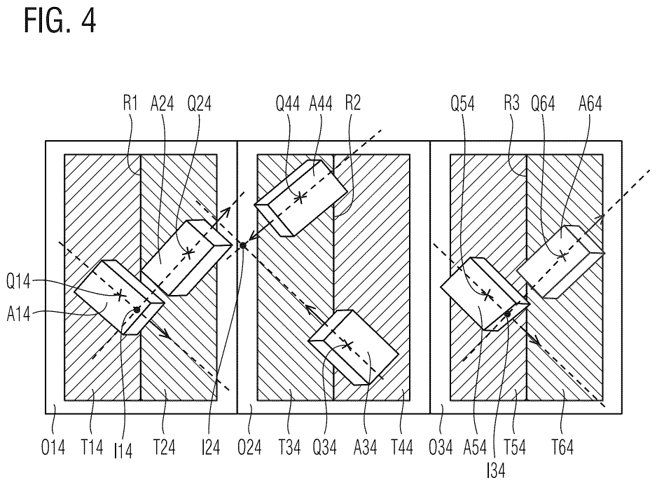

FIG. 3 is a plan view of a third embodiment example of the position measuring device according to the present disclosure. Again, only the significant differences from the above embodiment examples will be explained below.

As can be seen from FIG. 3, in this embodiment example the graduation marks of the measurement graduations and the measurement directions of the scanning units are slightly skewed by comparison with the two previous embodiment examples. In other words, the graduation marks of the measurement graduations and the measurement directions of the scanning units are arranged at an angle to either the main movement direction or a perpendicular to the main movement direction. The advantage of a configuration of this kind is that all the scanning units supply displacement-dependent position signals when the scanning assembly moves in the main movement direction, meaning that signal compensation or correction is always made possible.

FIG. 4 is a further plan view of a fourth embodiment example of the position measuring device according to the present disclosure. Again, only the significant differences from the above embodiment examples will be explained below.

As can be seen from the figure, each surface O14-O34 is assigned two measurement graduations T14/T24, T34/T44, T54/T64 of which the graduation marks are arranged in mirror symmetry with one another in relation to a central axis of symmetry R1, R2, R3 and at an angle to the main movement direction, which is oriented in the y direction here too.

Each of the three planes O14-O34 is also assigned a pair of scanning units A14-A64 of which the measurement directions are orthogonal to one another. Moreover, like in the previous embodiment examples, the measurement directions lie within the plane of the associated measurement graduations T14-T64.

In each scanning unit A14-A64, there is an imaginary straight line extending in line with the measurement direction starting from the scanning site Q14-Q64. For each of said pairs of scanning units, the above-described straight lines intersect at one point. This produces three points in the three-dimensional space, which are denoted in FIG. 4 by I14, I24, I34. These three points have to span a plane, i.e., they cannot be located on a shared straight line or coincide at one point, otherwise the position measuring device constructed in this way might not be able to determine the six degrees of movement independently of one another. Out of each of said pairs of scanning units, one measurement direction has to have a component perpendicular to said plane.

In this embodiment example, it can thus be advantageous if the offset or positioning in the main movement direction for one pair of scanning units among the scanning units is selected to be considerably different from that for the other pairs. For example, in accordance with FIG. 4, the distance between the scanning units A34, A44 over the middle surface having the two measurement graduations T34, T44 is considerably greater than the distance between each of the two other pairs of scanning units. Thus, the intersection point I24 is located at a different z coordinate compared with the two intersection points I14, I34 of the other pairs of scanning units. This ensures that the intersection points I14-I34 cannot be located on the same straight line.

In addition, if the surfaces O13-O34 each have pairs of measurement graduations for the two measurement directions, it can be provided that the graduation structures of one pair of these measurement graduations have a different orientation from the other two pairs of measurement graduations. For example, in accordance with FIG. 4 the mark directions of the pair of measurement graduations T34/T44 is rotated through 180° compared with the mark directions of the other pairs of measurement graduations T14/T24 and T54/T64. This measure can also help position the intersection points I14-I34 further away from a shared straight line.

It goes without saying that there are further embodiments within the context of the present disclosure in addition to the embodiment examples explained above.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A position measuring device for detecting a relative position of two objects, the objects being movable relative to one another in a translatory main movement direction and in further degrees of freedom, the measuring device comprising:
a scale carrier, which is elongate in the main movement direction and has a first, a second, and a third surface, which each define a plane, at least one measurement graduation being arranged on each of the first, second, and third surfaces; and
a scanning assembly that is configured to move relative to the scale carrier and comprises a plurality of scanning units configured to generate displacement-dependent position signals from scanning of the measurement graduations, each of the first, second, and third surfaces being assigned at least one of the plurality of scanning units,
wherein the plane defined by the second surface divides a surrounding space into two half-spaces,
wherein the first surface is arranged in a first half-space of the two half-spaces, and
wherein the third surface is arranged in a second half-space of the two half-spaces.

2. The position measuring device according to claim 1, wherein a first angle of intersection between the plane defined by the first surface and the plane defined by the second surface, and a second angle of intersection between the plane defined by the second surface and the plane defined by the third surface, are each selected in a range between 60° and 179°, the first angle of intersection being drawn in the first half-space, and the second angle of intersection being drawn in the second half-space.

3. The position measuring device according to claim 2, wherein the first and second angles of intersection are selected such that the plane defined by the first surface and the plane defined by the third surface are oriented in parallel with one another.

4. The position measuring device according to claim 1, wherein a first line of intersection between the plane defined by the first surface and the plane defined by the second surface, and a second line of intersection between the plane defined by the second surface and the plane defined by the third surface, are each oriented in parallel with the main movement direction, and wherein the second surface is located between the first and second lines of intersection.

5. The position measuring device according to claim 1, wherein the first, second, and third surfaces of the scale carrier, the measurement graduations, and the plurality of scanning units are arranged and configured such that a position of the scanning assembly relative to the scale carrier can be determined in six degrees of movement.

6. The position measuring device according to claim 1, wherein at least two of the first, second, and third surfaces are assigned at least two of the plurality of scanning units.

7. The position measuring device according to claim 1, wherein at least one of the first, second, and third surfaces is assigned two of the plurality of scanning units having different measurement directions, the measurement direction of one of the two scanning units indicating a translatory displacement direction in which the displacement-dependent position signals can be generated.

8. The position measuring device according to claim 7, wherein, on the at least one of the first, second, or third surfaces assigned to the scanning units having different measurement directions, the scale carrier has two differently oriented measurement graduations, graduation marks of which are not arranged in parallel with one another.

9. The position measuring device according to claim 1, wherein the measurement graduations are formed as incremental graduations that can be optically scanned.

10. The position measuring device according to claim 7, wherein:
each of the first, second, and third surfaces are assigned at least one of the plurality of scanning units of which a measurement direction is oriented perpendicularly to the main movement direction, and
the second surface and a further surface of the first or third surfaces are each assigned at least two of the plurality of scanning units of which the measurement directions are oriented perpendicularly to the main movement direction, and
at least one of the first, second, and third surfaces is assigned at least one of the plurality of scanning units of which the measurement direction is oriented in parallel with the main movement direction.

11. The position measuring device according to claim 7, wherein:
two adjacent surfaces of the first, second, and third surfaces are assigned four of the plurality of scanning units arranged in the main movement direction and having a measurement direction perpendicular to the main movement direction, and adjacent scanning units of the plurality of scanning units are each assigned to different surfaces of the first, second, and third surfaces, and
two further scanning units, at least one of which is assigned to a further surface of the first, second, and third surfaces that is not one of the two adjacent surfaces, are arranged in gaps between the four scanning units in the main movement direction.

12. The position measuring device according to claim 7, wherein graduation marks of the measurement graduations and the measurement directions of the scanning units are arranged at an angle to either the main movement direction or a perpendicular direction to the main movement direction.

13. The position measuring device according to claim 7, wherein:
each of the first, second, and third surfaces are assigned two measurement graduations of which graduation marks are arranged in mirror symmetry with one another in relation to a central axis of symmetry and at an angle to the main movement direction, and
the two measurement graduations on each of the first, second, and third surfaces are each assigned one of the plurality of scanning units, and the two scanning units of each of the first, second, and third surfaces having measurement directions that are orthogonal to one another.
